(19) United States
(12) Patent Application Publication
(10) Pub. No.: US 2009/0288679 A1
(43) Pub. Date: Nov. 26, 2009

(54) Apparatus and method for cleaning surfaces

(76) Inventors: Anton Pietsch, Del Mar, CA (US); George Lynch, Escondido, CA (US); Kevin Lynch, San Diego, CA (US); George Chang, San Diego, CA (US)

Correspondence Address: DAVID R PRESTON & ASSOCIATES APC, 5850 OBERLIN DRIVE, SUITE 300, SAN DIEGO, CA, 92121, US

(21) Appl. No.: 12/454,764

(22) Filed: May 22, 2009

Related U.S. Application Data
(60) Provisional application No. 61/128,571, filed on May 22, 2008.
(60) Provisional application No. 61/196,504, filed on Oct. 18, 2008.
(60) Provisional application No. 61/197,666, filed on Oct. 29, 2008.

(51) Int. Cl. B08B 3/12; B08B 3/00

(52) U.S. Cl. 134/1; 134/26; 134/95.3; 134/184

(57) ABSTRACT

The apparatus for cleaning surfaces of the present invention such as for cleaning solar collectors preferably alternates different fluids and gas decompression to create a cleansing fluid evacuation to clean outdoor solid surfaces. The method of the present invention utilizes alternating fluids in order to avoid mineral deposits contaminating the collector. The apparatus of the present invention is a tool to achieve the ends of the method. The apparatus preferably uses copper piping and turbulence to regulate water flow and to create the high velocity fluid evacuation that achieves the ends of the method invention. The use of a constant pressure pump and turbulence inducing fibers allows passive regulation of pressure that is equalized across a plurality of sprayers to deliver an even amount of high velocity fluid from each sprayer. Sonication accelerates cleaning, rinsing or snow/ice removal.

### CROSS REFERENCE TO RELATED APPLICATIONS

The present invention claims benefit of priority to U.S. provisional patent application Ser. No. 61/128,571, filed on May 22, 2008, provisional patent application Ser. No. 61/196,504, filed on Oct. 18, 2008, and provisional patent application Ser. No. 61/197,666, filed on Oct. 29, 2008, the entire contents of each of which are incorporated herein by reference in their entirety.

### TECHNICAL FIELD

The present invention relates to solar photo-voltaic (PV) panel arrays, to other solar collector systems that utilize reflecting concentrators or mirrors to increase the intensity or temperature of the sun's energy for conversion into useful forms of energy, and more generally, to surfaces that are exposed to the outdoor elements.

### BACKGROUND OF THE INVENTION

Solar energy collection systems are usually placed in an environment exposed to the outdoor elements. Some of these elements are detrimental to the optimal functioning of solar collectors when they attach to the collectors, including in a non-exhaustive list such things as dust, industrial and agricultural particulates, leaves, pollen, and bird droppings. All of these will contribute to an effective build-up of light scattering and shading elements that absorb or reflect some of the sun's energy and prevent it from being collected as intended for useful purposes. The amount and type of build-up varies with weather, location and other variables, but can typically cause a 5% loss of usable energy in as little as a few days, and a loss of more than 20% over a dry period of a few months.

These loses are multiplied by a factor of two or three for solar mirror or lens-based energy collection systems typically located on solar farms or other large array areas. Incident sunlight is scattered or shaded on the sunward surface coating, typically glass, reflected by a mirror or focused by a lens, and then diffused again upon exit towards the concentrator. If the concentrator also is surrounded by a glass, quartz or other solar spectrum transparent material, it is also subject to degradation from soiling, giving a third point of diffusion for the sun's energy before it is collected for useful conversion. This leads to an intensified effect of soiling that may require even more frequent need for cleaning to mitigate their negative effects.

In colder latitudes and seasons, solid water on top of surfaces is a significant problem. Snow adds weight to roofs and can require removal. It also is highly reflective and can diminish the efficiency of solar panels on roofs. An exhaustive list of surfaces that can be covered with snow or ice cannot be shown for reasons of space. Many of the possible surfaces that find themselves covered with various forms of solid water could benefit from a system or method to remove the solid water.

The use of home, commercial and utility solar panels is increasing due to ongoing concerns about energy prices and some encouragement of homeowners to use solar panels by multiple levels of government. Examples include the California Solar Initiative and federal Solar Tax Credit programs. These panels, mirrors and lenses need cleaning, and the prior art in solar panel cleaning leaves room for improvement.

Often these solar collection systems are located on rooftops or other physical locations that make them difficult to reach easily. For rooftops in particular, access to perform regular maintenance can be both hazardous to the person performing the maintenance operation and the additional weight and flexing of the rooftop surface may cause breakage of roofing materials. This, in addition to rooftop aging and the possible hidden deterioration of under-layers by dry rot or animal infestation present a particularly hazardous work-surface for performing manual maintenance.

Regularly occurring rainfall is usually effective at removing most naturally occurring sources of detrimental material in a fashion that is both uniform and of duration that will dissolve and wash away the majority of build-up. Rain is naturally deionized and neutral in pH so it does not leave deposits or adversely affect the components of the solar collection system. However, in regions where rainfall is episodic or periods of rainfall are separated by long intervals, rain may not be effective in removing build-up of deposits. Moreover, the summer season is frequently the highest production time for solar collection systems and corresponds with the least likelihood of regular rainfall.

Additionally, in areas of high natural humidity and organic growth, short sporadic rainfall may cause buildup of leaves or other organic material that the rain moistens but does not remove. In this case, rainfall may compound the soiling issue by encouraging the growth of algae, moss or fungus and further blocking collection of sunlight.

It is possible to convert lawn sprinklers or sprayers and install them on rooftops and use tap water or other sources of relatively unclean and impure water to avoid the hazards of roof access for regular maintenance. Alternatively, the roof could be cleaned with a hose and moped regularly. In both of these cases the use of tap water leaves open the likelihood of mineral deposition. After drying, mineral deposition leaves behind materials that have light reflective or absorbent properties. Moreover, typical lawn based plumbing systems are made of plastic that hardens and deteriorates under regular exposure to solar UV radiation, leading to failure of the cleaning system.

### SUMMARY

A solution to the problem of cleaning solid outdoor sun exposed surfaces is to use a sprinkler system of some kind. However, the problem of mineral encrustation with sprinklers itself requires a solution. One solution to that problem is the use of deionized water in washing.

A first aspect of the invention is a cleaning system including one or more of a commercially available deionization process, constant-pressure pumps, distribution manifolds, vessels for holding fluids, one-way valves, pipes to conduct fluids through the apparatus and sprayers.

The apparatus is a tool for accomplishing the method described above for a multi-cycle wash of solar collectors. The cleaning apparatus comprises manifold distribution elements, a plurality of sprayer elements, and pump station elements. The manifold distribution elements are generic fluid conducting pathways of greater diameter than the sprayer elements that reach to the topmost solar collection point and in some embodiments are exposed to the outdoor environment. It is envisioned that they will often be installed aloft or at a dangerous height in order to distribute the wash cycle fluids in an even fashion that will fully clean the solar collector under most circumstances. The invention utilizes for the manifold element preferably materials that are corrosion-resistant and durable under prolonged exposure to the sun, such as in a preferred embodiment, copper.

The manifold elements of the invention are fluid conducting tubes that take the liquid from where it is pumped to the sprayers. The fluid rises on one or more risers under pressure and is distributed along horizontal sections to the sprayers. The horizontal sections in a preferred embodiment are comprised of copper. However in another embodiment, where one or more horizontal sections are not exposed to the sun, the horizontal sections are comprised of PVC piping and protected from UV radiation and visibility by a roof cap, which is a common addition to residences at the apex of a roof.

The pump-station elements are connected to the manifold elements at least at a single point to the manifold elements and comprise an automated fluid preparation, storage and pumping stations that perform the wash cycle. In order for the pump-station elements to function properly within the invention as a whole the pumps preferably have a constant pressure rather than a constant volume. They may be located in a sheltered environment and hence need not be exposed to the full range of natural elements. The pump elements are further subdivided into controllers with sensors, valves for regulating transport of fluids, one or more pumps to transport from the station element to the manifold element, and fluid storage for each of the wash cycles and interconnection such that the wash cycle is performed when requested by the owner. All working fluids will be replenished as needed through periodic maintenance.

The sprayer elements each comprise a nozzle sub-element, pathway sub-element, and turbulent flow inducing sub-element. The sprayer elements themselves are spread out in a line along the distribution manifold pointing downwards. The sprayer elements are attached to the manifold element in such a way that the fluid can flow from through the manifold distribution elements to the sprayer elements.

The sprayers are preferably pointed downwards, and are preferably angled between an angle just short of perpendicular to the pull of gravity to pointing straight downward in the direction of gravity. The downward pointing nozzles utilize gravity to both flush out all of the water from the manifold element and to evenly distribute the washing cycle liquids. In a preferred embodiment the nozzle elements may be telescoping.

Assisting a nozzle sub-element is the turbulent flow sub-element or other flow restrictive sub-element. Turbulent flow evenly distributes pressure amongst all sprayer elements and allows for both efficient mixing of the water with detergents and causes the water in the manifold element to be evacuated from the sprayer elements at equal speeds. High capacity at high velocity evacuation can assist in preventing water losses to blowing wind. The turbulent flow inducing elements are comprised of coarse fibrous material or other non-linear flow restricting means nested inside the hollow tube sub-element.

The turbulent flow inducing sub-elements also function as passive regulators of fluid flow. Pressure regulators as practiced in the art may also produce the same effect. As the fluid velocity increases, the back-pressure does as well, so that the flow from the manifold to the sprayers is held generally constant through passive regulation without the need for active pressure regulators.

In another embodiment of the invention, the turbulent flow inducing sub-element is assisted by a telescoping downward sprayer element. In that embodiment the turbulence inducing sub-elements are accompanied by a series of progressively smaller cylinders that nest inside one another, forcing the fluid to travel up and down within the sprayer to finally exit out the nozzle. This creates fluidic impedance.

The passage elements connect the manifold distribution elements to the nozzles. They are hollow, and in addition to the fibrous mesh or other turbulence inducing means, are meant to allow passage of fluids from the manifold distribution element through itself and out the nozzles.

In order to maintain pressure communication between the manifold and the pump, pressure transducers, pre-amplifiers and sprayers are also a part of the apparatus in a preferred embodiment. They serve to help the constant pressure pumps maintain a constant pressure in a dynamic environment through informing the pump of what the pressure is at the exit point of the nozzle. In another embodiment, a pressure transducer at the exit point can communicate that pressure to the pre-amplifier which in turn acts upon the pumps that will have an analog response to the pressure from the pre-amplifier and either raise or lower pressure depending on the desired exit pressure.

A more complete understanding of the present invention may be obtained by reference to the accompanying drawings, when considered in conjunction with the subsequent, detailed description, in which: For purposes of clarity and brevity, like elements and components will bear the same designations and numbering throughout the Figures.

A second aspect of the invention is a cleaning system with one or more resonance inducers. In a preferred embodiment, resonance inducers should be placed in fluid distribution means, preferably close to the point of ejection from the means, such as in a downward sprayer of a fluid ejecting apparatus. An electromechanical pump at the beginning or end of a fluidic pathway that has a resonance inducer at the end of the pathway can pump at high pressure and instead of ejecting high velocity jets of fluid, less-high velocity, high energy vibration droplets of fluid are ejected. It will be appreciated by those skilled in the art that the pump need not be electromechanical, as virtually any energy source that imparts motive energy to a working fluid will do.

When ejected from the resonance inducers, the resonance energy in the sonicated droplets transfers energy to the liquid-solid interface on the surface of the solid object being cleaned, inducing turbulence when they hit a compositionally different substance. The turbulence is caused by the same sonic wave traveling in two different mediums in parallel. The turbulence causes a mixture of fluids that can assist in melting snow and removing debris from the solid surface.

The resonance inducers are objects preferably made of the same material as the pipe. It is shaped so as to impart resonance energy into the droplets before they are ejected. One possible shape by way of example only, is a sonicator. The resonance inducer can be keyed to a frequency by way of example only, of 5 kHz for pure water. The resonance inducer need not have 5000 pulses/second to be effective in water, but preferably has that many pulses as a sub-harmonic of the actual obtained frequency in a power series. By way of example only, a 500 or 2500 hertz base power series would be preferable to a frequency that does not have 5 kHz as a harmonic power series for water.

In one embodiment the length and resonance chamber of an inducer are manufactured in a manner such that the frequency of the combined wave is appropriate to the fluid that will be conveyed through the pipe. By way of example only, for water: a sub-harmonic of 5 kHz. In sonicator-type embodiments of the invention the internal dimensions of the sonicators are a dependent variable of the frequency desired.

The dimensions of a sonicator-type resonance inducer depend on variables such as the pressure of fluid flow, and the density of the fluid. However where a constant pressure can be maintained, the dimensions of the resonance inducer may also be fixed.

In a preferred embodiment the sonicators create a fluctuation of fluidic pressure within a small chamber. This is enough to create oscillation and transmit or transfer resonance energy. The oscillation works by creating a pressure differential in the liquid ejecting from a resonance device.

In one preferred embodiment the sonicator is comprised of two symmetrical parts preferably made of copper or a nonconductive material. In this preferred embodiment, the parts are two halves of the whole sonicator, divided along a co-linear axis. The halves are joined together so that they mirror and attach to one another. This creates a single structure where there is pressure oscillation in fluid's passage through the device.

The resonance inducers can also create frequency waves through any of several mechanisms appreciated by those skilled in the art. These include by way of non-limiting example: piezos, electromagnetic frequencies, loudspeakers, and in a preferred embodiment fluidic sonicators.

The sonicators create a power series wave through a simple passive sonicator mechanism. In a preferred embodiment the power series is a Green's function waveform repeated at a sub-harmonic of the fluidic mixing frequency. The sonicators are preferably inserted into the downward angled sprayer elements of a fluid ejecting apparatus. The sonicators comprise a chamber, an intake fluid passage and fluid outlet passage.

In a second embodiment, asymmetrical cavities, such as but not limited to reed-type oscillators in the sonicator are built into the chamber in order to get more energetic resonance waves.

In a preferred embodiment the power source for the resonance inducer is the kinetic energy in the bulk fluid. It shall be appreciated by those having skill in the art that other power sources for the resonance inducers would also have utility. These other power sources include mechanical, such as by way of example only, a hammer striking the resonance inducer, or electrical, such as by way of example only, an electrically powered device or piezo creating sonic resonance.

In a preferred embodiment the resonance inducer is part of a larger fluid distribution system such as a fluid distribution system into which fluid is pumped for ejection onto a surface by one or more sprayers. In that embodiment the sprayer houses the resonance inducer inside the sprayer.

A third aspect of the invention is a method for cleaning surfaces.

The invention comprises a multi-cycle wash system wherein first, tap, cistern, well or water obtained from other sources is separated into deionized water having an appropriate pH, preferably between 6 and 8 and saltier-than-tap water through any of several commercially available deionization systems, by way of non-limiting example, reverse osmosis. A solar collector panel is first washed with the saltier-than-tap water to remove light obstructions such as gross dirt, leaves and particulates as well as presoaking other materials. This presoaking increases the effectiveness of later steps by wetting larger deposits. In an optional embodiment of this invention this cycle may be repeated. The next step is for the collector panel to be washed with purified water from the tap which may include detergent to remove organic and mineral encrustations such as, in by way of non-limiting example, bird droppings or salt. The terminal step is to rinse the cleaned collector with deionized water having an appropriate pH, preferably between 7 and 8, optionally mixed with a surfactant to rinse off any remaining solutes. The surfactant may contain agents that assist in shedding additional dirt, ice or snow.

The transition from one liquid cycle to another is preferably followed by a gas cycle. The gas may be heated and may comprise ambient air or an inert gas. This gas cycle quickens the velocity and creates a high velocity outflow. The increased velocity makes for more efficient washing by a mist-like cleansing spray. It also flushes out the liquid cycle so that the next liquid cycle will not be contaminated by the previous liquid. The flushing effect allows for the different wash cycles with different fluids to be more fully segregated from one another and allows the deionized wash to follow a wash containing water with additional solutes.

A fourth aspect of the invention is a method for cleaning surfaces in freezing conditions. Energetically charged water should be mixed with the snow or ice. In order to enhance the use of energetically charged water, mixing between the solid water and fluid should be carried out. This speeds the melting process.

A preferred embodiment of this mixing method is to use a resonance wave in a fluid and have that wave propagated in the solid as well. Since the two mediums will have different rates of travel for the wave, turbulence and mixing will result. It will be appreciated by those of skill in the art that having the same wave in two mediums as a method for enhancing mixture will work to clean many surfaces including by way of example only, glass.

It will be appreciated by those having skill in the art that there are many ways to create a resonance wave. A non-exhaustive and non-limiting list of examples includes the use of piezos, striking near the outlet, electronically controlled sonic devices, and fluidic or solid mechanical pressure waves.

Using a fluid charged with resonance energy to clean a surface also improves general mixing near the surface. It will be appreciated by those having skill in the art that this mechanism allows for gains in cleaning and mixing as well as melting snow and ice.

### BRIEF DESCRIPTION OF THE DRAWINGS

FIG. 1 is a diagram of one aspect of the pump-station element that depicts the inputs of tap water, its separation through filtration, and storage in reservoirs. Also depicted are one aspect of the reservoirs for chemicals and valves for controlling the flow of those chemicals into the distribution manifold.

FIG. 2 is a drawing of one aspect of the manifold distribution element with said element's logical relationship to the plurality of sprayer elements and pump element.

FIG. 3 is a close up transverse section of one aspect of one of a plurality of the sprayer elements.

FIG. 4 is a block diagram of one aspect of the apparatus invention as a whole as it traces the flow of fluid through a preferred embodiment.

FIG. 5 is a block diagram of one aspect of the method invention for cleaning solar collection apparatuses.

FIG. 6 is a perspective view one aspect of the fluid inflow end of the resonance inducer for the second aspect of the invention.

FIG. 7 is a perspective view of aspect of the other end of the fluid outflow end of the resonance inducer for the second aspect of the invention.

FIG. 8 is a contextual view of one aspect of the resonance inducer to show where it would be inserted in a cleaning system.

FIG. 9 is a close-up transverse section view of one aspect of the low impedance transition 202 illustrated in FIG. 2.

FIG. 10 is a diagram of another embodiment of the pump-station element that uses a ballast-type blow-down tank for fluid delivery instead of a constant pressure pump.

FIG. 11 is a close-up transverse section view of another embodiment of the sprayer element.

### DEFINITIONS

Unless defined otherwise, all technical and scientific terms used herein have the same meaning as commonly understood by one of ordinary skill in the art to which this invention belongs. Where a term is provided in the singular, the inventors also contemplate the plural of that term. The nomenclature used herein is well known and commonly employed in the art. As employed throughout the disclosure, the following terms, unless otherwise indicated, shall be understood to have the following meanings:

Singular should be taken to include the plural, and plural should be taken to include the singular.

Striking refers to the use of an object hitting another object in a repetitive time-pattern.

Tap water refers to water obtained from a municipal tap, cistern, well, or other like sources.

Salty water refers to the waste water produced through the purification of tap water to become significantly deionized through Reverse Osmosis (RO), deionization column (DI), or other process that rejects a portion of the incoming water as part of the purification process.

An atmospheric blow-down tank functions in a manner similar to that of a ballast tank as utilized in underwater submarines to evacuate water using compressed air.

### INTRODUCTION

As a non-limiting introduction to the breadth of the present invention, the present invention includes several general and useful aspects, including:

1) An apparatus including one or more constant pressure pumps, fluid selection and distribution manifolds, one-way valves, fluid vessels, fluid vessel pipes, and downward pointing sprayer elements.

2) An apparatus with a resonance inducer to impart vibrational energy to a droplet.

3) A method for cleaning surfaces including cleaning a roof with a sequence of one or more liquids by passing pumped liquids through distribution systems and onto surfaces, The liquid steps including one or more of steps of salty water, steps of tap water, steps of deionized water. The liquid steps are dispensed onto a surface at high velocity from a plurality of sources.

### EXAMPLES

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

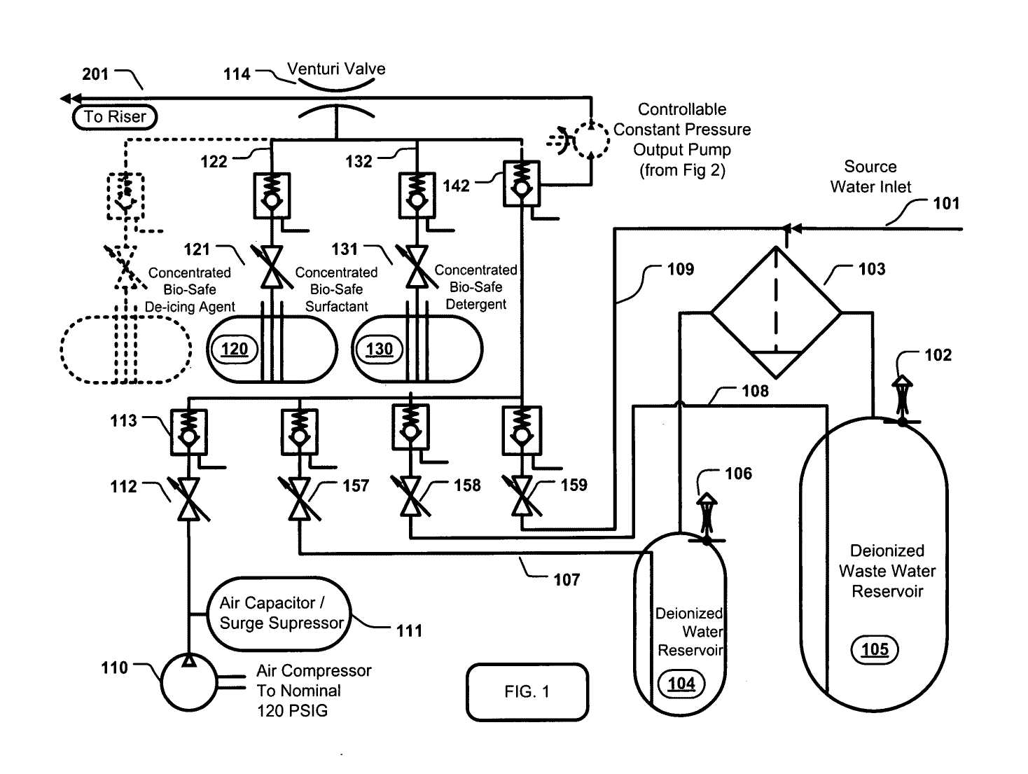

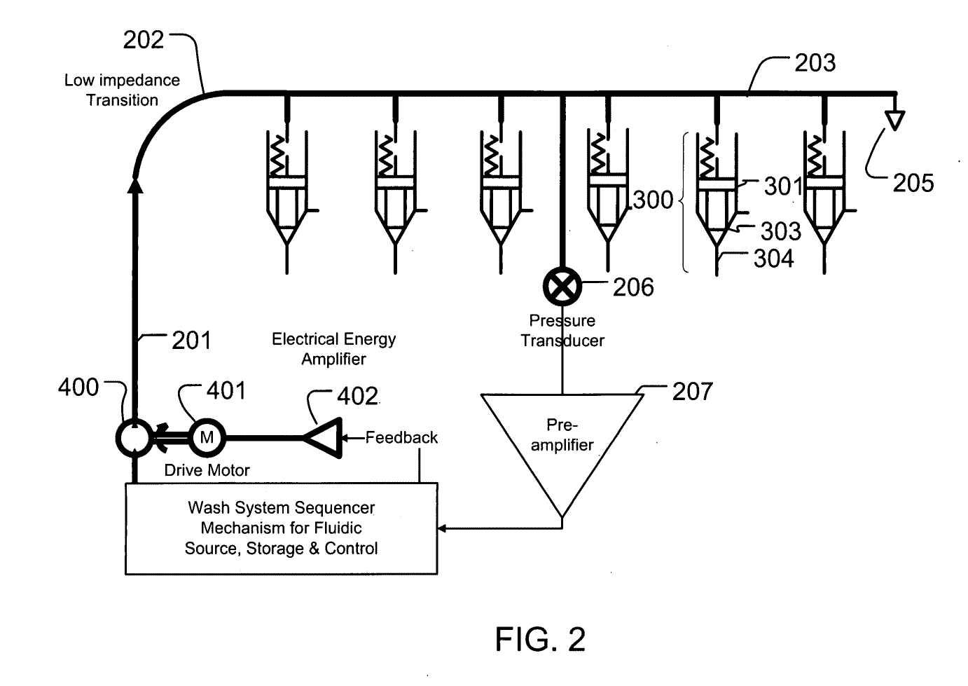

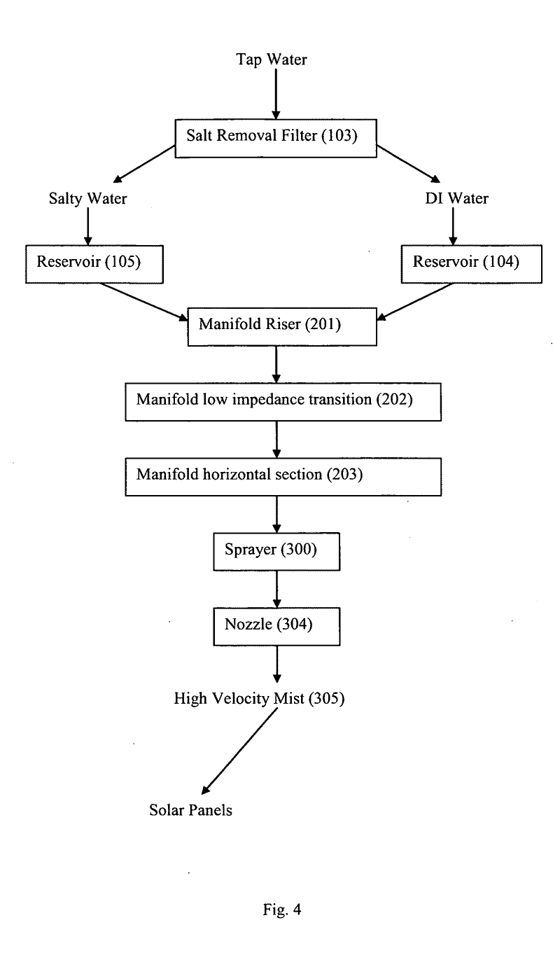

A preferred embodiment of the apparatus invention comprises one or more of 3 kinds of elements (see, for example, FIG. 4). The first kind of element of the embodiment are the pump-station elements 100 (see, for example, FIG. 1). The second kind of element of the embodiment are the manifold distribution elements 200 (see, for example, FIG. 2). The third kind of element of the invention are the sprayer elements 300 (see, for example, FIGS. 2, 3, and 8).

The pump station elements have the function of taking in tap water 101 and splitting it into deionized waste water, hereinafter referred to as salty water, and deionized water. This is accomplished through the use of one or more filters 103 which can be through by way of example only, reverse osmosis or deionization. The salty water is then conveyed through pipe 141 into salty water reservoir 105. The deionized water is conveyed to the deionized water reservoir 104. Both reservoirs are serviced with ambient air filters/pressure equalizer devices 102,106.

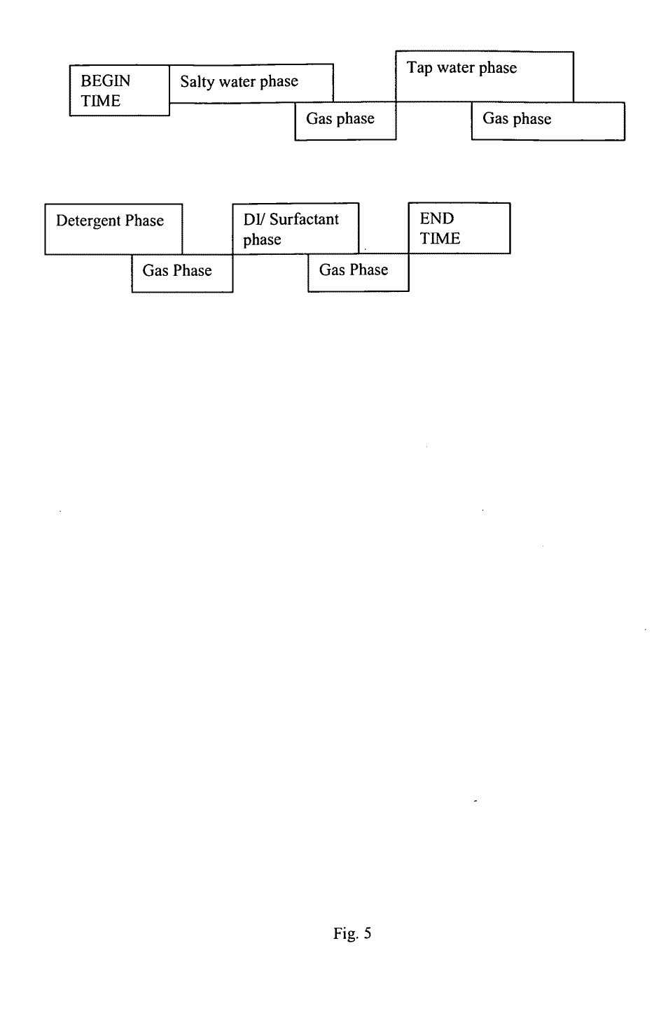

During the washing cycles various solvents such as by way of non-limiting example, surfactants and detergents will be used (see, for example, FIG. 5). The detergents are stored in a reservoir 130 that is controlled with a valve 131. The same is true of the surfactants 120,121. A vacuum relief valve 142 is placed between the fluid source and the wash cycle additives manifold and Venturi valve 114 to prevent cavitations. When fluid leaves the chemical reservoirs they are sent along a connector tube 122,123 to the manifold distribution element riser 201. The compressed gas follows a different pathway in that after passing the valve 112 they pass through a secondary manifold 113 before entering the riser 201. Access to the primary manifold is regulated with a valve or other device with substantially equivalent function 114. The liquid DI, salty water, and tap water enter the primary manifold riser 201 through their own passages 107,108,109. Their flow is regulated through valves 157,158,159 in order to regulate the sequence of fluids entering the primary manifold.

The wash cycles are assisted by an air compressor 110. The air output is regulated through a surge suppressor and capacitor cylinder 111 and valve 112. One-way valve 113 prevents backflow of liquid into the compressor 110. The expanding compressed air pushes liquid through the process adding to the creation of cleansing fluid evacuation 305 that cleans solar collectors.

Fluid and gases leave the pump-station elements through the manifold distribution elements 200. The pressure to generate fluid evacuation is generated by way of example only, a constant pressure pump 400 that maintains communication with the pressure in the manifold distribution element through a pressure transducer 206 and pre-amplifier 207.

The manifold distribution center comprises a riser 201 that takes the fluid up to the topmost point of cleaning. The impedance is reduced by a wide bending transition 202 to the horizontal section 203. Pressurized air may be released from the manifold distribution element through a porous terminating cap 205 at the end of the manifold distribution element distal to the pump-station element 100. Liquid however is retained by said porous terminating cap 205. Pressure communication is maintained with the constant pressure pump in a feedback loop through the use of a pressure transducer 206 and pre-amplifier 207. In a preferred embodiment the distribution manifold 200 is made from metallic copper or related alloy.

Fluid is evacuated from the distribution manifold 200 through a plurality of sprayers 300. The cleansing fluid evacuation 305 renders the cleaning both more effective and efficient.

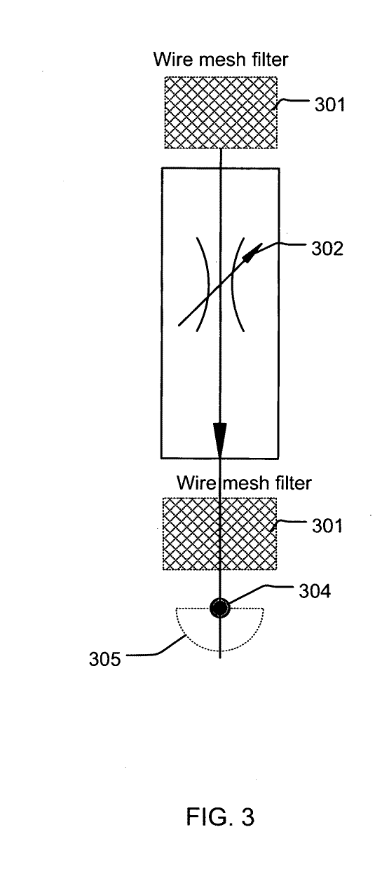

In FIG. 3 the sprayer elements 300 are shown from a transverse view looking at the interior of one of a plurality of sprayers. The mesh filters 301 function as a compressible washer and a particulate filter. This provides a leak free fit and enhances the effectiveness of the sprayer 300. The fluid is evacuated and falls through the passageway sub-element before finally leaving the invention as a cleansing fluid evacuation 305 through the nozzle 304. To regulate the flow of fluid through the sprayer is placed a turbulence inducing element 302 that will respond in a negative feedback-loop to the velocity of ejected liquid. As the velocity of the fluids leaving the system 305 increases so will the backpressure created by the turbulence inducing sub-element 302. This has the effect of creating a control system to regulate fluid evacuation from the apparatus. In a preferred embodiment the turbulence inducing sub-element 302 with relevant properties similar to but not necessarily limited by the properties of, Teflon, nylon, or PVCs.

### DESCRIPTION OF A PREFERRED EMBODIMENT OF THE SECOND ASPECT

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

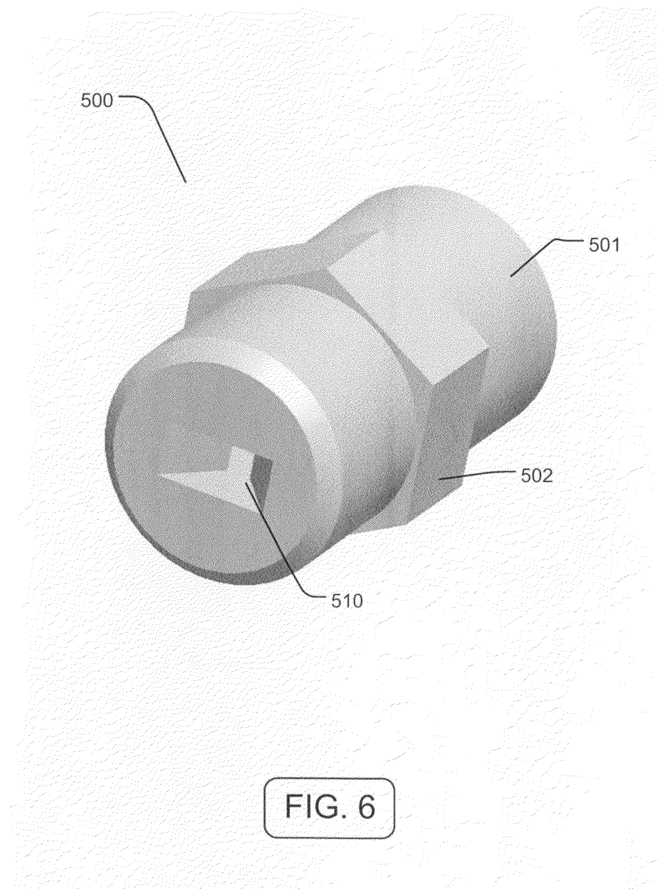

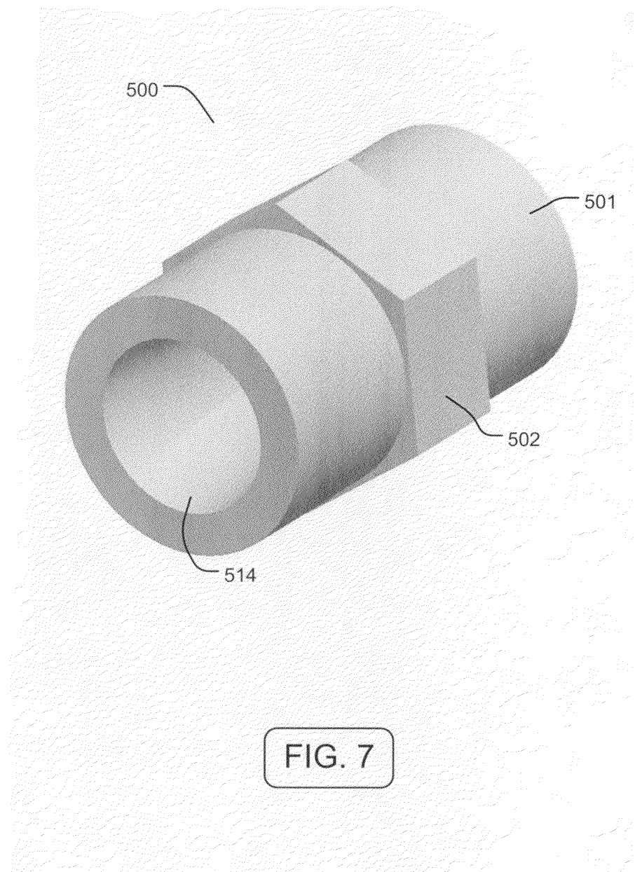

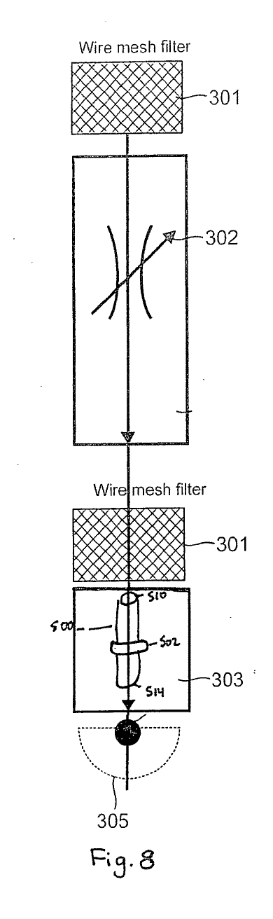

FIGS. 6-7 depict the resonance inducer as it would appear unattached to the remainder of the cleaning system. Not shown in those figures, but shown in FIG. 8 is a representative apparatus that would bring fluid to and from the resonance inducer. A preferred embodiment has a narrow fluid outlet 510 and a relatively broad fluidic intake 514.

Fluid travels until the pathway is bifurcated by the grooves 511 and squeeze passages 512. The internal grooves 511 then create the oscillation into one path that is the path of least resistance. The flanges 508 and 509 will alternate in having that status. Fluid will then exit alternately out of the device outlet 510 along flanges 508 and 509.

A supporting ring 502 assists in controlling and storing the vibration energy of the resonance inducer 500. In some embodiments of the invention in which the resonance inducer 500 is made from two parts it also holds the two parts together. In those embodiments the shaft 501 is actually made from two halves along the co-linear axis that is best shown by FIG. 8, which is sectioned along the co-linear axis.

FIG. 8 depicts where a resonance inducer 500 fits in the scheme of a fluid spraying apparatus. The device in which the resonance inducer is housed is the downward pointing sprayer of the first aspect of the invention. This is by way of example only and other arrangements are possible.

In a preferred embodiment the oscillation between pathways induced by fluid passing through the passages does so at a rate that is a sub-harmonic of 5000 Hz. By way of example only, 500 expansion-compression pulses per second would help induce resonance in the fluid. The dimensions of the resonance inducer are therefore a dependent variable of the pressure coming from the fluidic apparatus.

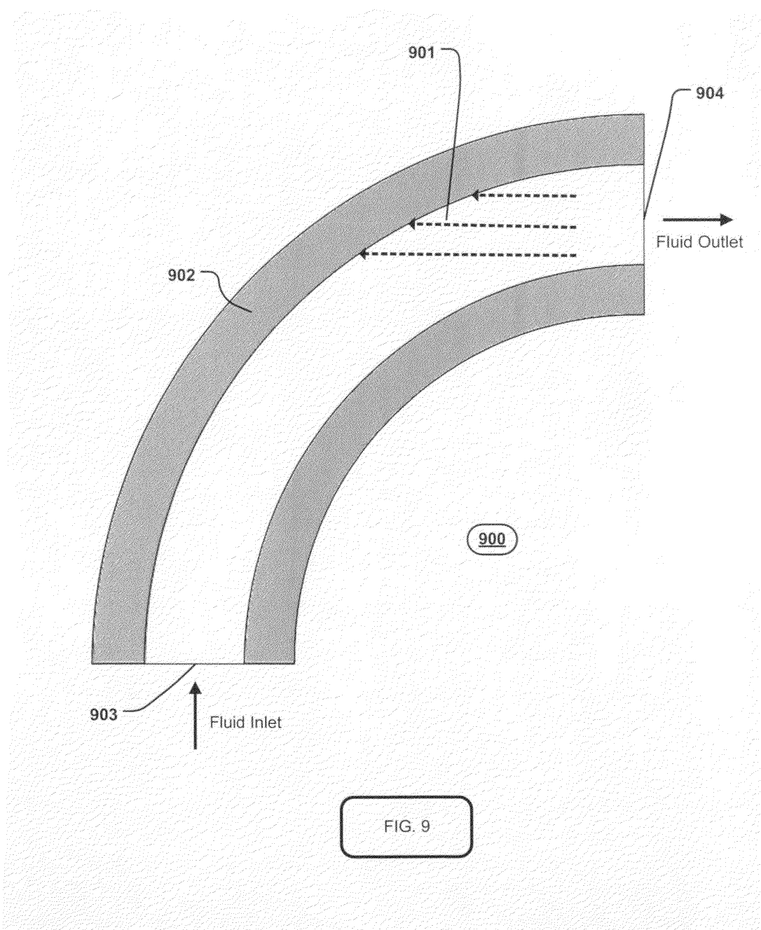

FIG. 9 depicts an embodiment of the low impedance transition 201. This transition serves two primary functions. First, the transition directs fluid flow from the riser element 201 at the fluid inlet 903 to the horizontal manifold section 203 at the fluid outlet 904 with minimal hydrodynamic loses. Second, the transition dampens pressure waves and acoustic noise 901 in the fluid that would otherwise travel down the riser element 201. This can be accomplished, by way of non-limiting example, by a tubular foam insert 902 and serves to reduce any water hammer effect known to those practiced in the art.

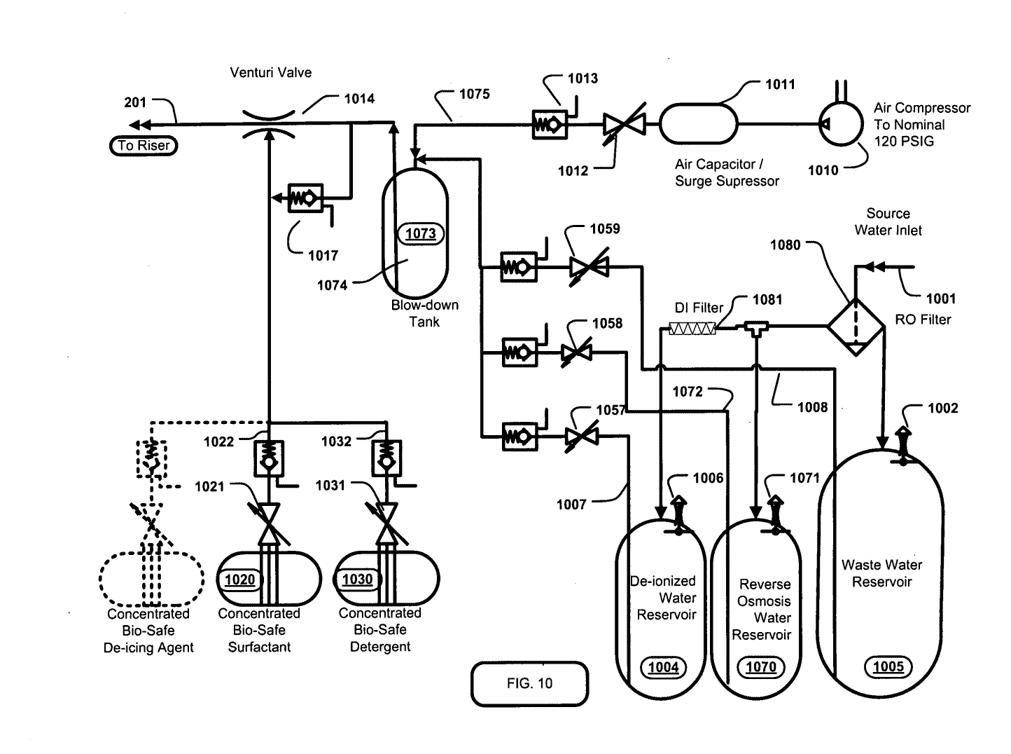

FIG. 10 describes another embodiment of the pump station apparatus. The following table lists elements of FIG. 1 that are functionally identical to elements of FIG. 10:

| FIG. 1 | FIG. 10 |
|---|---|
| 101 | 1001 |
| 102 | 1002 |
| 104 | 1004 |
| 105 | 1005 |
| 106 | 1006 |
| 107 | 1007 |
| 108 | 1008 |
| 110 | 1010 |
| 111 | 1011 |
| 112 | 1012 |
| 113 | 1013 |
| 114 | 1014 |
| 121 | 1021 |
| 122 | 1022 |
| 131 | 1031 |
| 132 | 1032 |
| 142 | 1042 |
| 157 | 1057 |
| 158 | 1058 |
| 159 | 1059 |

Reverse osmosis filter 1080 separates tap water into purified water for the reverse osmosis (RO) water reservoir 1070 and waste water for the waste water reservoir 1005. RO water is also further filtered in a de-ionizing filter 1081, after which de-ionized (DI) water is stored in 1004. In this embodiment the blow-down tank 1073 is used as an alternative means to deliver fluids to the manifold distribution element riser 201.

By way of non-limiting example, the blow-down tank is first filled with wash fluids from either reservoir 1004, 1070, or 1005, then valve 1012 is opened to deliver compressed air via passage 1075 to the blow-down tank 1073. The pressure increase at the liquid surface and forces wash fluids up the riser pipe 1074. Ambient air equalizer/filter 1071 is functionally identical to equalizer/filter 104, 105, 1004 and 1005. The fluidic passage 1072 is functionally identical to passages 107, 108, 1007 and 1008.

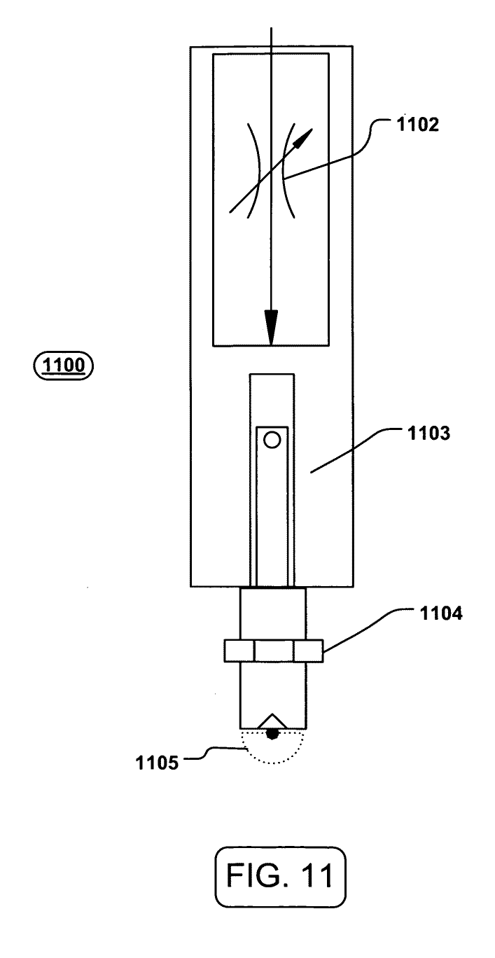

FIG. 11 illustrates another embodiment of the sprayer element. The following table lists elements of FIG. 3 that are functionally identical to elements of FIG. 11:

| FIG. 3 | FIG. 11 |
|---|---|
| 302 | 1102 |
| 304 | 1104 |
| 305 | 1105 |

The resonance inducer element 1103 is a cylindrical reed-type sonicator that employs a positive feedback mechanism to produce pressure oscillations in the wash fluid as it exits the nozzle 1104 as a cleaning spray 1105.

Having thus described the invention, what is desired to be protected by Letters Patent is presented in the subsequently appended claims.

What is claimed is:

1. An apparatus for cleaning a surface comprising:
a) one or more constant pressure pumps;
b) one or more fluid distribution manifolds;
c) one or more one-way valves;
d) one or more fluid vessels;
e) one or more fluid vessel pipes;
f) one or more downward pointing sprayer elements;
wherein said one or more constant pressure pumps are operably linked to said one or more fluid distribution manifolds;
wherein said one or more one-way valves are located along said fluid distribution manifolds below the linkage points of any of said one or more fluid vessel pipes to said one or more fluid distribution manifolds and above said one or more constant pressure pumps;
wherein said one or more fluid distribution manifolds link to said one or more fluid vessel pipes;
wherein said one or more fluid vessels are operably linked to said one or more fluid distribution manifolds through said one or more fluid vessel pipes;
wherein said one or more fluid distribution manifolds are oriented to have an approximately horizontal section above said one or more constant pressure pumps;
wherein said one or more approximately horizontal sections of the fluid distribution manifold are operably linked to said one or more downward pointing sprayer elements.

2. The apparatus of claim 1, wherein said one or more constant pressure pumps have performance in the range of between about 30 and about 120 PSI.

3. The apparatus of claim 1, wherein said one or more constant pressure pumps are regulated with a feedback mechanism located in the horizontal section of said one or more fluid distribution manifolds.

4. The apparatus of claim 1, wherein said one or more fluid distribution manifolds are copper or an alloy thereof.

5. The apparatus of claim 1, wherein said fluid distribution manifolds are linked to a pressure communication apparatus.

6. The apparatus of claim 1, wherein one or more of said one or more fluid vessels are equipped to contain reactive solvents.

7. The apparatus of claim 1, wherein said one or more fluid vessel pipes are regulated by valves;

8. The apparatus of claim 7, wherein said valves are controlled from a one or more control stations.

9. The apparatus of claim 1, wherein said one or more sprayers contain one or more turbulence inducing elements.

10. The apparatus of claim 1, wherein said one or more sprayer elements terminate in a nozzle.

11. The apparatus of claim 10, wherein said nozzle is telescoping.

12. The apparatus of claim 1, wherein said one or more sprayers contains a resonance inducer.

13. The apparatus of claim 12, wherein said resonance inducer is a sonicator-type inducer.

14. The apparatus of claim 13, wherein said sonicator-type inducer comprises 2 broad chambers.

15. The apparatus of claim 13, wherein said sonicator-type inducer is a reed-type sonicator.

16. The apparatus as in claim 1, wherein the surface to be cleaned comprises one or more solar panels, mirrors or similar environmentally exposed surfaces.

17. A method for cleaning surfaces comprising:
a) Cleaning a roof with a sequence of one or more liquids by passing pumped liquids through distribution systems and onto surfaces; The liquid steps comprising zero or more of
b) Steps of salty water;
c) Steps of tap water;
d) Steps of deionized water;
e) Said liquid steps are dispensed onto a surface as cleansing fluid evacuation from a plurality of sources;
wherein the steps are sequenced with said salty water step preceding said tap water step; Said tap water step followed by a step with deionized water;
wherein the fluids upon ejection from said distribution systems are delivered onto the surface at a high velocity and/or high energy content.

18. The method of claim 17, wherein one or more of the liquid steps is alternated with a gas step in which a gas is propelled through said pipe system.

19. The method of claim 18, wherein the gas used is ambient air.

20. The method of claim 18, wherein the gas used is an inert gas.

21. The method of claim 18, wherein the gas used is heated.

22. The method of claim 17, wherein the salty water is wastewater derived from deionization of tap water.

23. The method of claim 17, wherein one or more of the sequenced tap water steps is mixed with a detergent.

24. The method of claim 23, wherein one or more of said sequenced detergent/tap water mixed steps uses a detergent comprising a solution of pH between about 7 and about 8.

25. The method of claim 17, wherein one or more of the deionized water steps comprises deionized water derived from the deionization of tap water.

26. The method of claim 17, wherein a surfactant is mixed with one or more of the deionized water steps.

27. The method of claim 17, wherein the cleansing fluid evacuation is generated with one or more downward pointing nozzles.

28. The method of claim 17, wherein the last liquid step uses a surfactant.

29. The method of claim 17, wherein the surface is a solar panel or other surface environmentally exposed to the sun's radiation.

30. The method of claim 17, wherein said method is applied using the apparatus of claim 1.

31. The method of claim 17, wherein one or more of said liquids is imparted with resonance energy by means of resonance induction before it reaches said surface to be cleaned.

32. The method of claim 31, wherein said means of resonance energy consists of a sonicator.

33. The method of claim 32, wherein said sonicator is a reed-type sonicator.

34. An article of manufacture comprising:
a) one or more resonance inducers; and
b) one or more fluid distribution means;
wherein at least one of said one or more resonance inducers is operably linked to said one or more fluid distribution means.

35. The article of manufacture of claim 34, wherein at least one of said resonance inducers operate by means of a sonic energy source.

36. The article of manufacture of claim 35, wherein said means of a sonic energy source is a reed-type sonicator.

37. The article of manufacture of claim 35, wherein at least one of said resonance inducers has dimensions proportional to the nozzle flow rate sufficient to drive sonication.

38. The article of manufacture of claim 34, wherein at least one of said resonance inducers comprise one or more piezos.

39. The article of manufacture of claim 34, wherein at least one of said resonance inducers operate through a non-sine wave.

40. The article of manufacture of claim 39, wherein said non-sine wave is generated through an expansion/compression wave.

41. The article of manufacture of claim 39, wherein said non-sine wave is a power series of sine waves.

42. The article of manufacture of claim 41, wherein said power series approximates a Green's function waveform.

43. The article of manufacture of claim 34, wherein at least one of said one or more resonance inducers operates by an object striking the liquid distribution means.

44. The article of manufacture of claim 34, wherein at least one of said one or more fluid distribution means comprises one or more nozzles.

45. The article of manufacture of claim 44, wherein at least one of said one or more nozzles is operably linked to a sprayer.

46. The article of manufacture of claim 45, wherein at least one of said sprayers is downward pointing.

47. The article of manufacture of claim 34, wherein at least one of said one or more fluid distribution means comprises one or more constant pressure pumps.

48. The article of manufacture of claim 34, wherein at least one of said one or more fluid distribution means comprises one or more hoses.

49. The article of manufacture of claim 34, wherein at least one of said one or more fluid distribution means comprises one or more pipes.

50. The article of manufacture of claim 49, wherein at least one of said one or more pipes comprises copper or a related alloy.

51. The article of manufacture of claim 34, wherein at least one of said one or more fluid distribution means comprise one or more sprayers.

52. The article of manufacture of claim 51, wherein at least one of said one or more sprayers is pointed in a direction that is angled in the direction of gravity.

53. The article of manufacture of claim 51, wherein at least one of said downward pointing sprayers comprises said one or more resonance inducers within the downward pointing sprayers.

54. The article of manufacture of claim 51, wherein at least one of said sprayers comprises a turbulence inducing means.

55. The article of manufacture of claim 54, wherein at least one of said turbulence inducing means comprises fiberglass or a similar insoluble mesh weave.

56. The article of manufacture of claim 34, wherein at least one of said one or more fluid distribution means comprises one or more power sources.

57. The article of manufacture of claim 56, wherein at least one of said one or more power sources is electrical.

58. The article of manufacture of claim 56, wherein at least one of said one or more power sources is mechanical.

59. The article of manufacture of claim 56, wherein at least one of said on or more power sources is from the bulk fluid.

60. The article of manufacture of claim 34, wherein said article is hand operable.

61. The article of manufacture of claim 34, wherein at least one of said one or more fluid distribution means is mobile vehicle mounted.
